(19) United States
(12) Patent Application Publication
(10) Pub. No.: US 2004/0103365 A1
(43) Pub. Date: May 27, 2004

(54) System, method, and computer program product for an integrated spreadsheet and database

(76) Inventor: Alan Cox, Swansea (GB)

Correspondence Address: MOORE & VAN ALLEN, PLLC, 2200 W MAIN STREET, SUITE 800, DURHAM, NC, 27705, US

(21) Appl. No.: 10/065,877

(22) Filed: Nov. 27, 2002

(51) Int. Cl. G06F 15/00

(52) U.S. Cl. 715/503

(57) ABSTRACT

A system for applying spreadsheet and database operations to one or more original worksheets resulting in a new worksheet representative of the spreadsheet and database operations. The system includes a relational algebra engine, a re-mapping engine, and a computation engine. The relational algebra engine performs relational algebra operations contained in the original worksheet(s) and creates a temporary results table. The relational algebra engine also creates a mapping table correlating the original worksheet cells with the temporary results table. The re-mapping engine adjusts spreadsheet operations that refer to original worksheet cells to refer to the temporary results table. The re-mapping engine then creates a re-mapped worksheet containing the adjusted spreadsheet operations and the results of the relational algebra operations. Finally, the computation engine reads the re-mapped worksheet and recalculates spreadsheet values that have been adjusted to create the new worksheet.

### BACKGROUND OF INVENTION

The spreadsheet and the database have long been viewed as two separate but interoperable systems. Several patents relate to the inter-working of database and spreadsheet systems. However, all of them deal with moving data efficiently between the two representations. For instance, U.S. Pat. No. 5,966,716 describes a method of creating spreadsheet forms so that data entered into different form instances is automatically stored in a single database. U.S. Pat. No. 5,319,777 describes a method of connecting spreadsheets through a local area network (LAN) in which the spreadsheets are separate from the databases upon which they operate. And, U.S. Pat. No. 5,293,615 describes a method of allowing a spreadsheet to query a separate database.

What is needed, however, is a tool that can integrate the advantages of both the spreadsheet and the database into a single system.

### SUMMARY OF INVENTION

The present invention discloses a system, method, and computer program for integrating the characteristics of a spreadsheet and the relational abilities of a database. Database relational abilities are those typically expressed in database languages such as, for instance, the software query language (SQL). Integration of a spreadsheet and database differs from the methods cited in the references above which typically refer to manipulating and moving data between spreadsheets and databases.

A spreadsheet is a document comprised of one or more worksheets each of which contains a two dimensional grid of values termed cells. The utility of a spreadsheet stems from a cell's ability to contain equations that can be computed using the values of other individual cells, rows of cells, columns of cells, or ranges thereof.

A database, in contrast, comprises one or more tables each of which contains a grid of values. Relational algebra is typically used to add and retrieve data to/from the database. The tables are defined so that each row represents a property and each column an item having such properties. Relational algebra and the query languages that are commonly used to process the relational algebra are designed to retrieve and select groups of items that have properties matching a rule. Rules are defined by the user and applied to the database. The result of the application of a rule to the database is a list of values that fit squarely within the rule.

In accordance with the present invention there is disclosed a system and method for applying spreadsheet and database operations to the cells of one or more original worksheets resulting in a new worksheet representative of the results of the spreadsheet and database operations. The present invention comprises a relational algebra engine, a re-mapping engine, and a computation engine. The relational algebra engine reads data contained in the cells of the original worksheets and performs any relational algebra operations contained therein. The relational algebra engine then creates a temporary results table comprised of cells containing the results of the performed relational algebra operations and also creates a mapping table correlating the cells of the original worksheets with the cells in the results table. The re-mapping engine reads the mapping table created by the relational algebra engine and adjusts spreadsheet operations that refer to cells in the original worksheets to refer to the cells in the results table. The re-mapping engine then creates a re-mapped worksheet containing the adjusted spreadsheet operations and the results of the relational algebra operations. Finally, the computation engine reads the re-mapped worksheet and recalculates spreadsheet values that have been adjusted to create the new worksheet.

### BRIEF DESCRIPTION OF DRAWINGS

FIG. 1 illustrates a sample spreadsheet.

FIG. 2 illustrates a data structure for use with the present invention.

FIG. 3 illustrates a logic diagram describing the process of creating a new worksheet by executing the operations within the cells of an original worksheet.

FIG. 4 illustrates the process for computing a new cell.

FIG. 5 illustrates the process for creating a re-mapped worksheet using the new cells.

FIG. 6 illustrates the re-mapping process.

FIG. 7 illustrates a computer based embodiment of the present invention.

### DETAILED DESCRIPTION

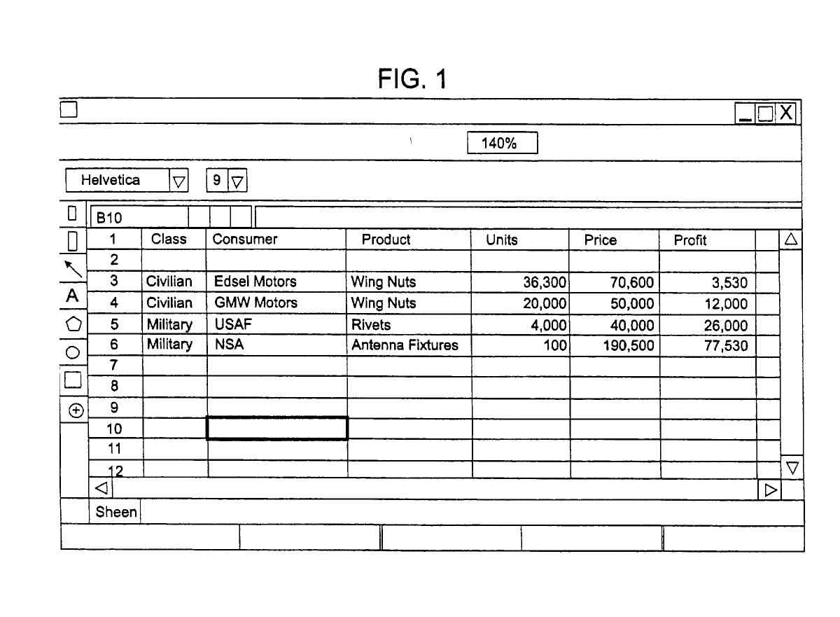

Consider a fragment of a typical spreadsheet entitled “Goods” as shown in FIG. 1. There are six columns shown representing six related categories. Under each category are values pertaining to that category. In this example, the categories are class, customer, product, units, price, and profit. The values for each category are stored in individual cells of the spreadsheet organized in columns. Spreadsheet operations allow for easy manipulation of numeric values in the cells. For instance, a user can generate sums for prices, profit and other desired information relatively easy by creating equations that reference the cell(s) containing the numeric values. In the present example, cell E7 contains the total price of all goods sold and cell F7 contains the total profit on all goods sold.

This data can also be viewed as a table in a database. When treated as a database, a user can perform a whole series of innovative operations on the spreadsheet itself. For example, a user can construct new worksheets that continue to have the spreadsheet data and equations intact. For instance, published sales data may not want to include military data. In a conventional spreadsheet there is no mechanism for expressing partial worksheets based upon database operations. The present invention, however, allows for the efficient expression of the desired operations without having to manually generate new spreadsheets or import/export data to separate databases.

There are at least four significant features of the present invention. One feature can be referred to as creating a “Simple View” of spreadsheet data. A simple view is comprised of a subset of a spreadsheet as defined by relational database operation(s). The effect of a simple view is to change the way data in the original spreadsheet is viewed in the new spreadsheet. The result does not affect spreadsheet calculations or cell values. The original spreadsheet that the simple view was generated from remains unchanged and the operations performed on that spreadsheet are also unchanged.

In the sample spreadsheet of FIG. 1, and assuming SQL (or some other database query language), a desired simple view of civilian only data can be generated according to the following query: SELECT * FROM Goods WHERE CLASS !=‘Military’ the desired values been imported into a separate database, the embedded spreadsheet information on how to calculate the data would have been lost.

The second feature is referred to as a “Complex View”. In the simple view, the new spreadsheet displays total values that are the same as the original spreadsheet. That is, while we may see only civilian data, the calculations for the total data still reflect military data as well.

Sometimes, however, it may be desirable that the spreadsheet calculations be computed with only the new view in mind. The spreadsheet cell values and its references to other cells in the original spreadsheet are recomputed as if the new view constituted all of the data. In other words, in a complex view of civilian price and profit data, the totals will be recomputed not to include the military price and profit data. This entails re-defining the spreadsheet operations based on the user-defined database operations.

Moreover, a view need not be confined to a single spreadsheet. Since relational algebra permits a ‘JOIN’ operator to express the combination of multiple tables (i.e., multiple spreadsheet worksheets) a user can selectively and powerfully combine spreadsheet worksheets into a single view and use this resulting view as if it were a spreadsheet worksheet itself.

The third significant feature is to create a new spreadsheet from one or more other spreadsheets. For instance, if a user only desired customer names he could issue the query: SELECT “customer” from Goods This would create a new spreadsheet in which only the selected customer(s) would be included. It is obvious to those skilled in database manipulation that such an operation can also include other relational database operators such as ‘JOIN’ to combine data from multiple spreadsheets. The new spreadsheets function similar to simple and complex views but also create copies of the data and spreadsheet operations in the new spreadsheet.

The fourth significant feature with respect to integrating spreadsheet and database functionality involves embedding relational algebra directly into the computation of a spreadsheet. It is relatively easy to calculate sums in a spreadsheet but often hard to calculate sums for specific groups of items on the fly without careful spreadsheet design. Embedding relational algebra into the cells of a spreadsheet makes such a task relatively simple. In the example spreadsheet of FIG. 1, civilian sums can be calculated by adding cells containing the following expressions, written in some suitable spreadsheet and database language combination such as: [Sum (SELECT PRICE WHERE CLASS !=‘Military’)] even though the spreadsheet worksheet was not defined with this in mind. By using ‘JOIN’ relational operators, importing the results of queries from other worksheets or combinations of worksheets is a relatively simple task.

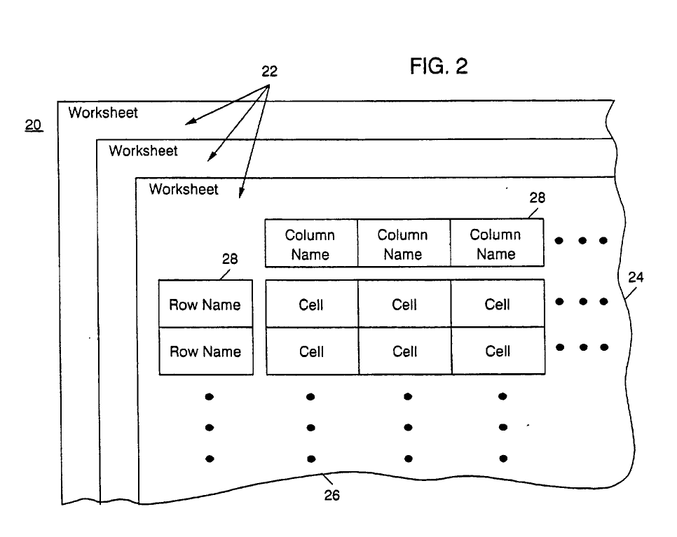

To implement the aforementioned features, the present invention comprises a data structure, a relational algebra engine, a computation engine, and a re-mapping engine. The data structure 20, as shown in FIG. 2, is comprised of one or more worksheets 22 each of which contains a plurality of rows 24 and columns 26. The rows 24 and columns 26 may also have names 28 which is typical of databases. Each cell 30 of the data structure 20 can hold values and/or expressions. Expressions can be encodings of mathematical operators, equations, references to other cells and/or relational algebra, or combinations thereof.

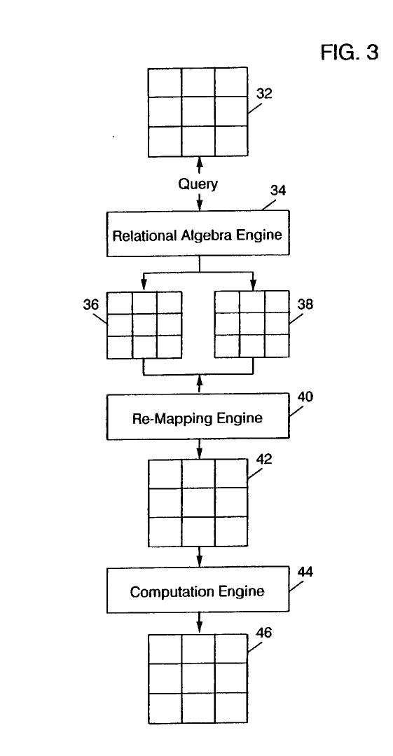

Referring now to FIG. 3, the process of creating a new worksheet from an original worksheet using both spreadsheet and database operations is described. A worksheet is a subset of a spreadsheet in that a spreadsheet can be comprised of multiple worksheets. The present invention can create a new worksheet that references one or more existing worksheets. Since relational algebra operations can be involved in the process, the existing worksheets need not be confined to the same spreadsheet. That is, a new worksheet can be created by referencing multiple existing worksheets that may span more than one spreadsheet. Moreover, universal resource identifiers (URI) or universal resource locators (URL) can be used to specify the location of worksheets or portions of worksheets. This allows for creation of new worksheets using data from local or remote sources. Sources of data may even be referenced according to Internet addresses.

A relational algebra engine 34 is for computing relational algebra, expressed in some format such as SQL. The relational algebra engine 34 reads data from an original worksheet(s) 32 and creates a temporary results table 36 that is the result of relational algebra operation performed on the original worksheet 32. The relational algebra engine 34 also creates a mapping table 38 of cells between the original worksheet(s) 32 and the results table 36. The mapping table 38 describes where cells in the original worksheet(s) 32 are now located in the results table 36 as a result of a relational database operation.

A re-mapping engine 40 reads the mapping table 38 and adjusts spreadsheet operations that refer to cells in the original worksheet 32 so that they refer to the new cell locations in the results table 36. For example, if a relational algebra operation removed rows 2 and 3, then references to rows 4 or higher in the original worksheet 32 would be adjusted to reference a row that is two rows higher than before. References to data that has been removed by a relational algebra operation become references to an appropriate “null” value, which can be zero, a blank space, or something else as dictated by the relational algebra operation. The output of the re-mapping engine 40 is a re-mapped worksheet 42. The re-mapped worksheet 42 contains the results of relational database operations as well as spreadsheet operations that have been adjusted to reflect the re-mapped worksheet 42 layout.

A computation engine 44 reads the re-mapped worksheet 42 and recalculates spreadsheet values that are not yet up to date in the re-mapped worksheet 42. One example of such a calculation would be the sum of a particular row. The result of the computation engine is a new worksheet 46 ready for display that has been constructed using both relational database operations and normal spreadsheet operations.

When a user creates a new worksheet using relational algebra, the original worksheet(s) are queried using the relational algebra engine and a pair of temporary tables returned including a results table derived from the relational algebra engine computations and a mapping table. The results table and mapping table are then fed to the re-mapping engine yielding a re-mapped worksheet where the cells that contained references to parts of the original worksheet now contain references to the same data within the new worksheet. To correlate old cells with new cells, the re-mapped worksheet is then recomputed using the computation engine to bring the values up to date with the changed content. The end result is an updated new worksheet.

When references between worksheets are supported by the computation engine, every worksheet referenced is fed to the re-mapping engine along with the mapping table, the cells referencing the modified worksheet are adjusted to reference the new location of these cells, and re-computation is performed by the computation engine. Views are created by the same process described above, however, each cell in the view becomes a reference to the cell in the original worksheet(s) from which the view is constructed.

When a complex view is generated, fields in the new worksheet that contain expressions instead of values are fed to the re-mapping engine along with the mapping table created when the relational algebra used to compute the view was processed by the relational algebra engine creating the new worksheet. The complex view is then processed by the computation engine.

When a mixture of complex and simple view data is present, each cell that is defined to be a simple view becomes a reference, and each cell that is a complex view cell is processed as described above. The new worksheet is then processed by the computation engine.

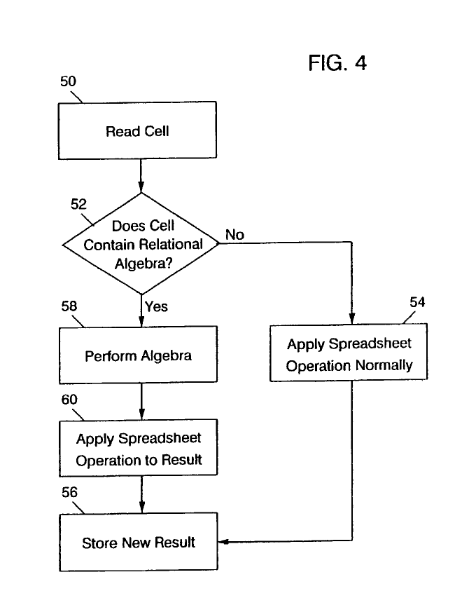

FIG. 4 illustrates the process for computing a new cell by executing the contents of a cell in the original worksheet. This process is repeated for each cell in the original worksheet.

A worksheet is comprised of a collection of cells. Thus, to create a new worksheet from one or more existing worksheets, each cell in the new worksheet is computed based on relationships and operations to other cells referenced. The first step is to read the contents of the cell 50 to be computed from the original worksheet. The contents of the cell are checked to determine if any relational algebra is present 52. Relational algebra refers to database operations, either alone or in combination with spreadsheet operations. If there is no relational algebra present in the cell then spreadsheet operations in the cell are applied in a normal fashion 54 (e.g., sum of row 5) and the result of those operations is stored as a new result 56 in the cell. If, however, there is relational algebra present in the cell, then the relational algebra operations are executed 58. The relational algebra operations are computed using a standard SQL, or the like, yielding a temporary results table. Next, any spreadsheet operations (e.g., sum of row 5) are applied 60 to the result of the relational algebra operations. The result is stored as a new result 56 for the cell value and is placed alongside any equations so that the current results can be displayed to a user.

To compute a new cell, the present invention checks for the presence of relational algebra operations. These operations, if they exist, are performed first prior to applying the result to normal spreadsheet operations.

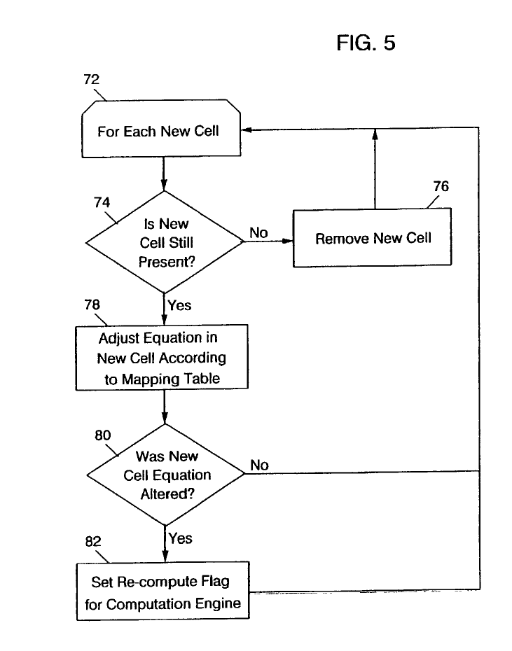

FIG. 5 illustrates the process for creating the re-mapped worksheet. FIG. 4 described the process of computing new cells by executing the operations contained in each cell of an original worksheet. The operations could have included relational algebra and/or normal spreadsheet operations. Once the new values have been temporarily placed into a results table and a correlating mapping table, a mapped worksheet is created to account for relational algebra operations that may have altered the dimensions (e.g., number of cells) in the original worksheet.

The process for creating a re-mapped worksheet 42 is a series of steps 72 performed on each new cell. The first step is to ensure that the cell is still present 74 following the previous computations. This is achieved by checking the mapping table 38 to determine whether the cell in question still exists or whether it was deleted as the result of a relational algebra operation. If the cell was deleted according to the mapping table, then the cell is removed 76 from the results table and will not appear in the re-mapped worksheet 42. The process then increments and the next cell is checked 72. If the cell is still present following the previous computations, then it's equation is adjusted 78 according to the mapping table 38. Adjusting the equation entails modifying the equation so that any references to a specific row, column, or other cell in the original worksheet are altered to reflect the new locations of these cells if they exist. For instance, if a relational algebra operation such as a database select had the effect of removing column 0 from the original sheet, then the new cell would be modified so that references to column 1 would become references to column 0. Similarly any other column references would be decremented by one since the entire table has been shifted one column to the left by the database operation. The next step is to determine whether the equation was indeed altered 80. If it was not altered, then the next cell is read into the process 72. Otherwise a flag is set 82 reminding the computation engine 44 that this cell is out of date and must be recomputed prior to returning the final new worksheet 46. Once the flag is set the process loops back to operate on the next cell 72. The entire process repeats until there are no more cells to check.

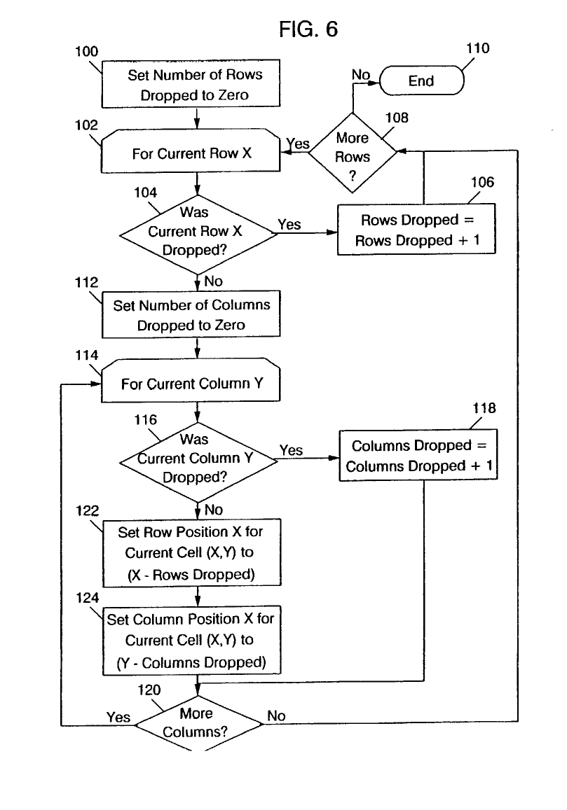

FIG. 6 illustrates the re-mapping process. The re-mapping process is responsible for determining the new row and column positions for cells in the re-mapped worksheet 42. The re-mapping process iteratively evaluates each row and column to determine whether it was dropped or retained as a result of previous operations. Rows and columns that were dropped cause a shift in the cells of the re-mapped, worksheet that must be taken into account.

The process is essentially a pair of nested loops, one loop for rows and one loop for columns. The first step is to initialize a rows dropped parameter to zero 100 prior to entering the outer loop. This means that the outer loop will increment by rows and the inner loop will increment by columns until all cells have been processed. It does not matter whether the row loop or column loop is the outer loop, however.

Step 102 is the start of the row loop. The first step 104 in the outer loop is to determine whether the current row, X, was dropped based on a previous operation. If the current row was dropped, then the rows dropped parameter is incremented by one 106 and control is sent to a decision box to determine if more rows are present 108. If not, the re-mapping process is terminated 110. Otherwise, control is returned to the start of the row loop 102 so that the next row may be processed. If the current row was not dropped, then control is passed to a loop for each column. Prior to entering the column loop, however, a columns dropped parameter is initialized to zero 112 . Similar to the row process, a check is made to determine whether the current column, Y, was dropped 116 due to a previous operation. If the current column was dropped, then the columns dropped parameter is incremented by one 118 and control is sent to a decision box to determine if more columns are present 120. If no more columns are present, then control is sent to the decision box 108 to determine if more rows are present. Otherwise, if there are more columns, control is returned to the start of the column loop 114 so that the next column can be processed. When a column has been determined as not having been dropped, then the new row and column cell positions are fixed for the current cell. The row position for the current cell (X,Y) is set by subtracting the current value of the rows dropped parameter from the current value of X in step 122. The column position for the current cell (X,Y) is set by subtracting the current value of the columns dropped parameter from the current value of Y in step 124. Once the new cell positions have been determined a check is made to see if more columns are present 120. The process continues until all rows and columns have been processed.

The present invention can be used to create new worksheets based on specific instructions. Some of the instructions may be database operations and some may be spreadsheet operations. The database operations can also query separate conventional databases while simultaneously helping create a new worksheet. For instance, a new worksheet may be requested for clients owing more than $50,000. This could require database operations as well as spreadsheet operations. The source data for the spreadsheet operations may be dispersed over multiple worksheets that need to be summed to determine if the $50,000 threshold is met. Once the new worksheet has been generated, one may wish to merge the results with address data for the clients that can be obtained in a separate company database so that a letter to the clients can be generated regarding the outstanding amounts owed. In this example, the present invention has used the database operations to identify clients owing more than $50,000 and a simultaneous database operation has been performed retrieving the addresses for such clients.

In order to keep this explanation clear optimizations have been omitted. It is obvious to anyone experienced in this field that the processing described herein can occur in parallel, on a cell by cell basis, at the time the cell data is required, and/or can be avoided when it is already known that the cell, row, column or worksheet in question is not affected by changed to another sheet.

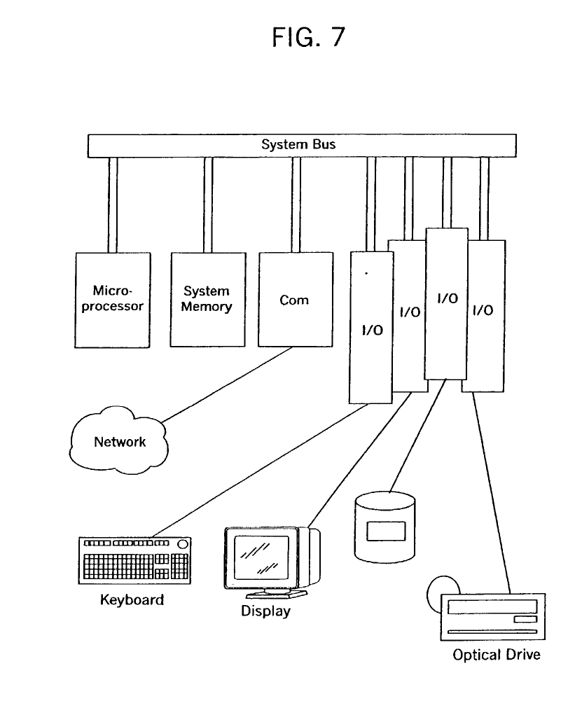

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any hardware described herein form the various means for carrying out the functions of the invention in the example embodiments. See FIG. 7.

Specific embodiments of an invention are described herein. One of ordinary skill in the telecommunication arts will quickly recognize that the invention has other applications in other environments. In fact, many embodiments and implementations are possible. The appended claims are not intended to limit the scope of the invention to the specific embodiments described above. In addition, the recitation “means for” is intended to evoke a means-plus reading of an element in a claim, whereas, any elements that do not specifically use that recitation are not intended to be read as means-plus-function elements, even if they otherwise include the word “means.

1. A system for applying spreadsheet and database operations to the cells of one or more original worksheets resulting in a new worksheet representative of spreadsheet and database operations, comprising:
a relational algebra engine for:
performing relational algebra operations contained in the original worksheets;
creating a temporary results table comprising the results of the performed relational algebra operations; and
creating a mapping table correlating the original worksheet cells with the temporary results table,
a re-mapping engine for:
adjusting spreadsheet operations that refer to the original worksheet cells to refer to the temporary results table; and
creating a re-mapped worksheet containing the adjusted spreadsheet operations and the results of the relational algebra operations, and a computation engine for:
recalculating spreadsheet values that have been adjusted to create the new worksheet.

2. The system of claim 1 wherein a cell numbering scheme is applied to the new worksheet rather than a database naming scheme.

3. The system of claim 1 wherein universal resource identifiers (URI) can be to specify the location of one or more original worksheets.

4. The system of claim 1 wherein the relational algebra operations can simultaneously query the original worksheets and a separate database.

5. A method of applying spreadsheet and database operations to the cells of one or more original worksheets resulting in a new worksheet representative of spreadsheet and database operations, comprising:
performing relational algebra operations contained in the original worksheets;
creating a temporary results table comprising the results of the performed relational algebra operations;
creating a mapping table correlating the original worksheet cells with the temporary results table;
adjusting spreadsheet operations that refer to original worksheet cells to refer to the temporary results table;
creating a re-mapped worksheet containing the adjusted spreadsheet operations and the results of the relational algebra operations; and
recalculating spreadsheet values that have been adjusted to create the new worksheet.

6. The method of claim 5 wherein a cell numbering scheme is applied to the new worksheet rather than a database naming scheme.

7. The method of claim 5 wherein universal resource identifiers (URI) can be used to specify the location of one or more original worksheets.

8. The method of claim 5 wherein the relational algebra operations can simultaneously query the original worksheets and a separate database.

9. A computer program product including a computer program for applying spreadsheet and database operations to the cells of one or more original worksheets resulting in a new worksheet representative of spreadsheet and database operations, the computer program comprising:
instructions for creating a temporary results table containing the results of relational algebra operations contained in the original worksheet cells;
instructions for creating a mapping table correlating the original worksheet cells with the temporary results table;
instructions for adjusting spreadsheet operations that refer the original worksheet cells to refer to the temporary results table;
instructions for creating a re-mapped worksheet containing the adjusted spreadsheet operations and the results of the relational algebra operations; and
instructions for recalculating spreadsheet values that have been adjusted to create the new worksheet.

10. The computer program product of claim 9 wherein the computer program further comprises instructions for providing a cell numbering scheme to the new worksheet rather than a database naming scheme.

11. The computer program product of claim 9 wherein universal resource identifiers (URI) can be used to specify the location of one or more original worksheets.

12. The computer program product of claim 9 wherein the relational algebra operations can simultaneously query the original worksheets and a separate database.

13. A system for applying spreadsheet and database operations, to the cells of one or more original worksheets resulting in a new worksheet representative of spreadsheet and database operations, comprising:
means for performing relational algebra operations contained in the original worksheet cells;
means for creating a temporary results table comprising the results of the performed relational algebra operations;
means for creating a mapping table correlating original worksheet cells with the temporary results table;
means for adjusting spreadsheet operations that refer to original worksheet cells to refer to the temporary results table;
means for creating a re-mapped worksheet containing the adjusted spreadsheet operations and the results of the relational algebra operations; and
means for recalculating spreadsheet values that have been adjusted to create the new worksheet.

14. The system of claim 13 wherein a cell numbering scheme is applied to the new worksheet rather than a database naming scheme.

15. The system of claim 13 wherein universal resource identifiers (URI) can be used to specify the location of one or more original worksheets.

16. The system of claim 13 wherein the relational algebra operations can simultaneously query the original worksheets and a separate database.
